(19) United States
(12) Patent Application Publication
(10) Pub. No.: US 2016/0044399 A1
(43) Pub. Date: Feb. 11, 2016

(54) EARBUD CORD ADAPTOR FOR SHARED LISTENING

(71) Applicant: Jean Oscar, Chicago, IL (US)

(72) Inventor: Jean Oscar, Chicago, IL (US)

(21) Appl. No.: 14/452,077

(22) Filed: Aug. 5, 2014

(51) Int. Cl. H04R 1/10; H04R 5/033; H04R 3/12

(52) U.S. Cl. CPC H04R 1/1033; H04R 3/12; H04R 5/033; H04R 2420/09

(57) ABSTRACT

An earbud cord as for an audio player is provided with a supplemental, parallel receptacle for connecting a second plug for a second earbud cord, so as to provide signals from the audio player to a second set of earbuds without interrupting or disrupting the listening of the first user. The plug, earbuds, receptacle, and cord can be of any convenient construction, as a mini-phono plug, mini-USB port, Firewire, or the like.

### FIELD OF THE INVENTION

The invention relates to music sharing devices for use with portable players and earbuds.

### BACKGROUND OF THE ART

Systems and devices for individuals' listening to music by way of earbuds connected to portable music players are very common since the 1980's, the Sony Walkman being among the first and Apple's iPod being a popular current product. Such devices do not directly power speakers for listening by two or more people, but the single set of connected earbuds must be exchanged between the potential listeners unless a “splitter” device is used. Known splitters plug directly into the output port of a player and comprise an extra port for connecting a second earbud set to the player. These devices require that the first user's earbuds be disconnected from the player and the splitter be inserted for connection of the second earbuds, interrupting the first user's listening until the interchange is complete. Duobud, Splitterbot, iglobal, and other devices serve the prior purpose but have that interruption disadvantage, unless the splitter is left on the music player or carried with it, which has the different disadvantage of adding to fragility and weight of the player system.

### SUMMARY OF THE INVENTION

It is an object of this invention to provide a convenient, always-accessible second receptacle port for connecting a friend's earbuds to one's earbud cord for sharing music and other audio signals from a portable player. The added port is lightweight and readily accessible to friends for sharing on-going music signals, without interruption in the first user's listening enjoyment.

The invention comprises adding an earbud plug receptacle port into the cord between the jack for engaging the player and the first user's earbuds. The second receptacle port is wired electrically in parallel to the channel circuit in the cord, to provide identical listening to the second and first listeners. Such receptacles are light in weight and small in size and so can be kept ready for sharing at all times without disconnecting the first user's earbuds to allow the second user access to the music stream from the player. Any or all of telephone jack, USB, Firewire, and other connection systems can be used.

### BRIEF DESCRIPTION OF THE DRAWINGS

FIG. 1 is a schematic view of a cord set according to the present invention, with portions of the cords broken away.

FIG. 2 is a schematic vies of a portion of an alternative cord set, with a USB receptacle for use with that different type of ear bud connector.

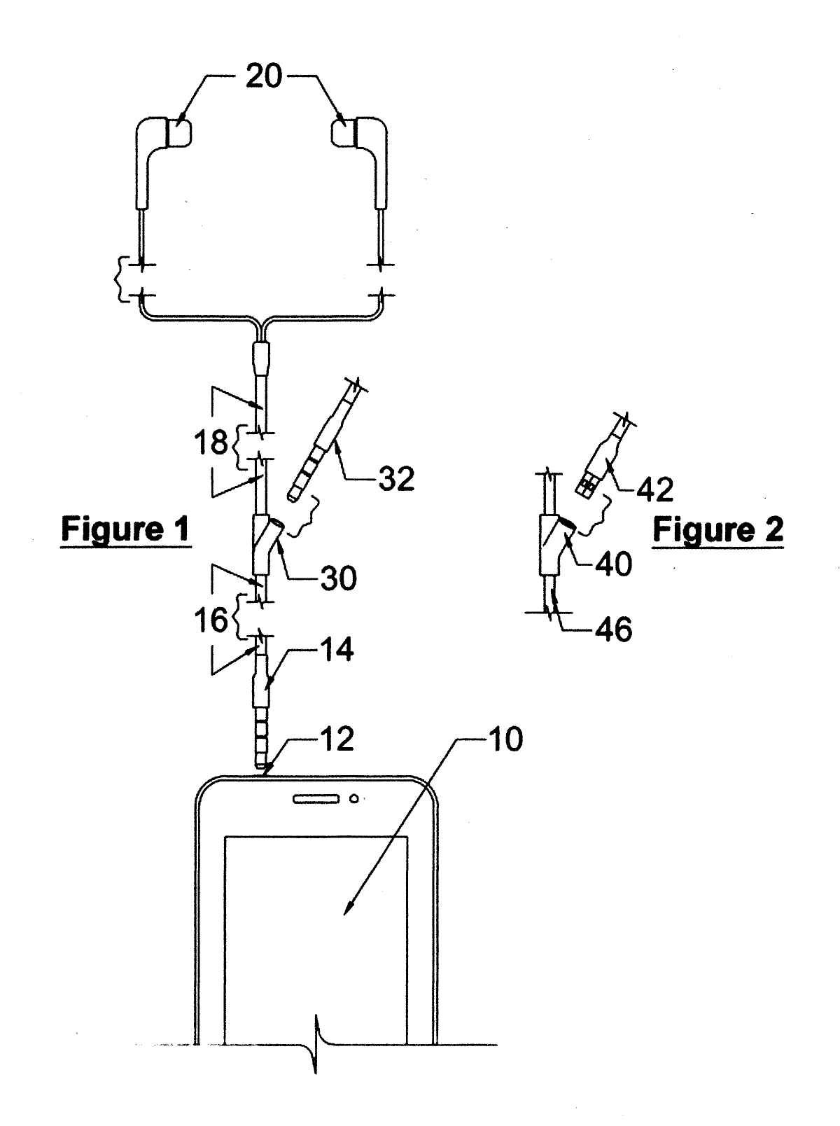

### THE PREFERRED EMBODIMENTS

A portable music player 10 of any current commercial variety has a plug receptacle port 12 on its exterior adapted to receive a conventional miniature plug 14 of an earbud cord set 16, 18. The cord 18 extends for a convenient length and splits to separate left and right earbuds 20, all as is well known in the art. For some music players 10 different connectors are used, as miniature USB ports, Firewire®, and other known and coming technologies. Bluetooth® and other communication technologies can also be used, alone or in conjunction with wired connections as shown.

In accordance with principles of the present invention, a splitter 30 is provided in the cord 16, 18. This splitter 30 is internally wired in parallel with the plug 14 and earbuds 20, to provide monaural or stereo signals to the second cord set 32, which has its own earbuds, not shown, for use by a second person in listening to music or other audio signals from the one player 10.

Any suitable wired connector besides a phono plug 14 may be used in the invention, as a miniature USB connector as at 40 set into a different cord set 44 as in FIG. 2, for use with cord set 42 as shown.

Electrical connections for the one or two channels of music among the player outlet 12, the plug 14, the earbuds 20, and splitter 30 or 42 are conventional and readily known to those of ordinary skill in the pertinent art.

Other features may be added into the new system without departing from the invention, as a miniature switch may be added in the splitter connector 30 or 40. These and any of many other variations may be made in the invention as shown and its manner of use, without departing from the principles of the invention as described herein and/or as claimed as the invention. Minor variations will not avoid the use of the invention.

I claim as my invention:

1. In a first earbud set for a first user's listening to audio information from an output receptacle on a player, the first earbud set comprising an earbud for engaging with said user's ear, a plug for engaging with said receptacle on the player and for connecting to least one audio channel generated by or through said player, and a conductive cord connecting the plug and the earbud electrically to provide said information and music to the user's ear, an improvement for adapting the cord of the first earbud set to accept a second plug connected electrically to a second earbud set of a second user, the improvement comprising:
a second output receptacle carried on and electrically connected into the cord of the first earbud set and to the audio channel from the player carried on the conductive cord;
whereby a second earbud set may selectively be connected to the first earbud set and the player without interrupting the listening of the user of the first earbud set.

2. The improvement of claim 1, wherein
the information is provided by the player in two channels,
the first earbud set is adapted for providing stereo sound to the first user, and
the second receptacle is adapted to provide stereo information to a user of the second earbud set.

3. The improvement of claim 1, wherein each of the first and second receptacles is a USB port.

4. The improvement of claim 1, wherein at least one of the first and second receptacles accepts a stereo plug.

5. An earbud cord and jack assembly for passing signals from a player to a first earbud set for a first user, the assembly comprising:
a connector to signals generated in the player,
an electrically conductive cord connecting the connector to the earbud, and
a receptacle means in and carried on the cord for connecting a second earbud set to the player,
whereby said second earbud set can be connected to pass the signals from the player to a second user via a second earbud set without interrupting the signals sent to the first earbud set.
